(19) United States
(12) Patent Application Publication
(10) Pub. No.: US 2018/0011547 A1
(43) Pub. Date: Jan. 11, 2018

(54) KEY TOP AND KEYBOARD

(71) Applicant: FUJITSU COMPONENT LIMITED, Tokyo (JP)

(72) Inventor: Hiroki SATOU, Tokyo (JP)

(73) Assignee: FUJITSU COMPONENT LIMITED, Tokyo (JP)

(21) Appl. No.: 15/621,295

(22) Filed: Jun. 13, 2017

(30) Foreign Application Priority Data
Jul. 5, 2016 (JP) 2016-133766

(51) Int. Cl. G06F 3/02; H01H 13/83; G06F 1/16

(52) U.S. Cl. CPC G06F 3/0202; H01H 13/83; G06F 1/1662

(57) ABSTRACT

A key top including: a transparent substrate that includes a ceiling part, and a side wall part; a first layer having a chromatic color with transparency that is formed on a top face of the ceiling part and an outer wall of the side wall part or a bottom face of the ceiling part and an inner wall of the side wall part; and a second layer that is a whitish color, white, silver or gold, is formed on the first layer, and shields a light from a light source, a part of the second layer corresponding to a character part being removed; wherein a contrast ratio between colors of the first and the second layers at the time of non-lighting is 3:1 or more, and a luminance of the light passing through the character part at the time of lighting is 3 cd/cm² or more.

### CROSS-REFERENCE TO RELATED APPLICATION

This application is based upon and claims the benefit of priority of the prior Japanese Patent Application No. 2016-133766 filed on Jul. 5, 2016, the entire contents of which are incorporated herein by reference.

### FIELD

A certain aspect of the embodiments is related to a key top and a keyboard.

### BACKGROUND

There has been conventionally known a key top that is mounted on a keyboard with a backlight and transmits a light (e.g. see Japanese Laid-open Patent Publications No. 2004-126409, No. 2004-126408 and No. 2005-17356). In a normal keyboard with the backlight, a character part on the key top is a transparent whitish color, and a part other than the character part is a blackish deep color. Thereby, the key top secures a contrast between a color of the character part and a color of the part other than the character part at the time of non-lighting of the backlight, and the character part transmits the light from the backlight at the time of lighting of the backlight, and hence improves the visibility thereof.

Moreover, there has also been known a key top in which the character part on the key top is the transparent whitish color and the part other than the character part is white, silver or gold.

### SUMMARY

According to an aspect of the present invention, there is provided a key top including: a transparent substrate that includes a ceiling part, and a side wall part extending vertically downward from the ceiling part; a first layer having a chromatic color with transparency that is formed on a top face of the ceiling part and an outer wall of the side wall part or a bottom face of the ceiling part and an inner wall of the side wall part; and a second layer that is a whitish color, white, silver or gold, is formed on the first layer, and shields a light from a light source, a part of the second layer corresponding to a character part being removed; wherein a contrast ratio between a color of the second layer and a color of the first layer at the time of non-lighting of the light source is 3:1 or more, and a luminance of the light passing through the character part at the time of lighting of the light source is 3 cd/cm² or more.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating a keyboard according to a first embodiment;

FIG. 1B is a diagram illustrating a key top to be mounted on the keyboard;

FIG. 2A is a cross-section diagram taken along line A-A of FIG. 1B;

FIG. 2B is a diagram illustrating a variation of FIG. 2A;

FIG. 3A is a flowchart illustrating a method of manufacturing the key top;

FIG. 3B is a flowchart illustrating a variation of FIG. 3A;

FIG. 4A is a cross-section diagram taken along line A-A of FIG. 1B according to a second embodiment;

FIG. 4B is a diagram illustrating a variation of FIG. 4A;

FIG. 5A is a flowchart illustrating a method of manufacturing the key top according to the second embodiment; and

FIG. 5B is a flowchart illustrating a variation of FIG. 5A.

### DESCRIPTION OF EMBODIMENTS

When the character part on the key top is the transparent whitish color and the part other than the character part is the white, silver or gold, the character part needs to transmit the light at the time of lighting of the backlight, and the transparent whitish color therefore is employed.

However, in the time of non-lighting of the backlight, a contrast ratio between the transparent whitish color and the white, silver or gold is low, and therefore there is a problem that the visibility of the character part is deteriorated. In order to improve the contrast ratio at the time of non-lighting of the backlight, the character part can be changed to a blackish color. However, when the character part is changed to the blackish color, there is a possibility that a required character part is cut off at the time of laser cutting, and further a permeability of the light is deteriorated at the time of lighting of the backlight.

A description will now be given of an embodiment according to the present invention with reference to drawings.

### First Embodiment

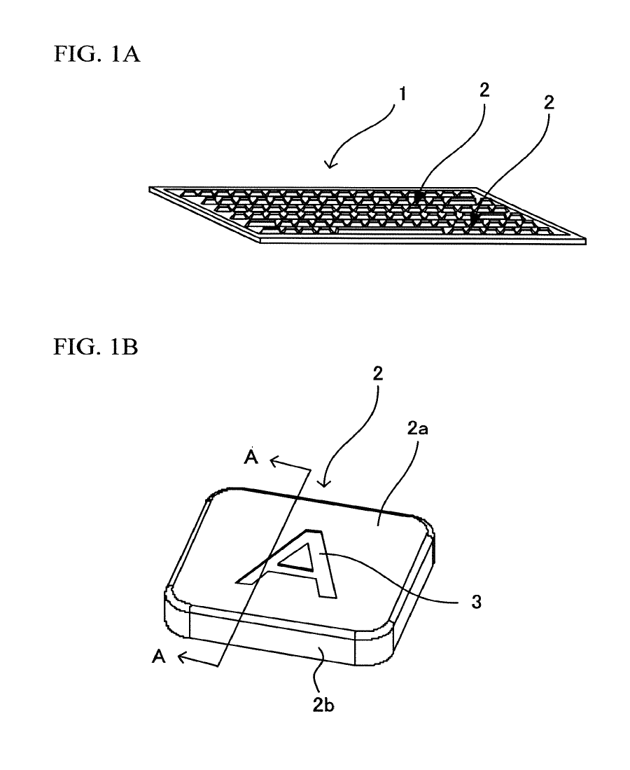

FIG. 1A is a diagram illustrating a keyboard according to a first embodiment. FIG. 1B is a diagram illustrating a key top to be mounted on the keyboard.

A keyboard 1 of FIG. 1 A has a plurality of key switches, and each key switch includes a key top 2. The keyboard 1 includes a backlight and a light guide plate, not shown. The keyboard 1 is a stand-alone keyboard, but may be a keyboard that is mounted on a notebook computer or a console drawer. The key top 2 of FIG. 1B includes a top face 2a and a side face 2b. A character part 3 is formed on the top face 2a. The character part 3 is a character, a numeral, a mark, a figure or the like. The character part 3 transmits a light from the backlight or the light guide plate arranged under the key top 2. The side face 2b and a domain of the top face 2a other than the character part 3 serve as a light-shielding part that shields the light from the backlight or the light guide plate. Here, the backlight is composed of a LED (light emitting diode) or an organic EL element.

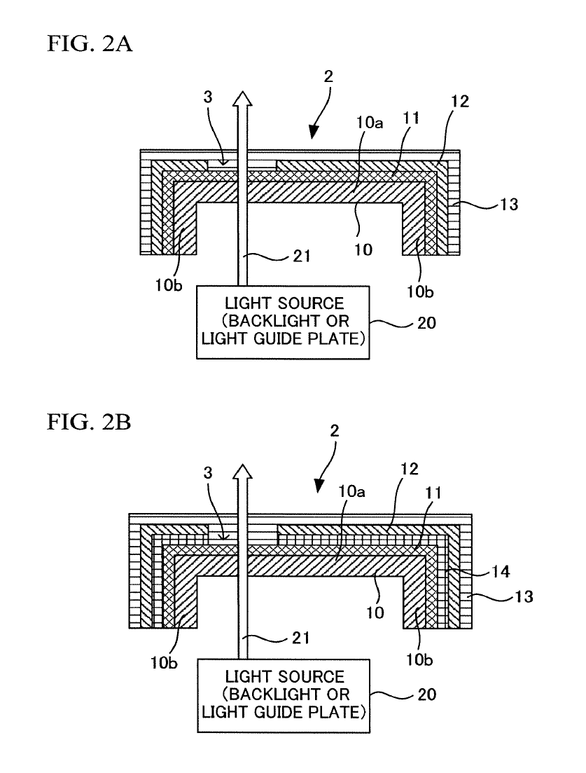

FIG. 2A is a cross-section diagram taken along line A-A of FIG. 1B. FIG. 2B is a diagram illustrating a variation of FIG. 2A.

The key top 2 of FIG. 2A includes: a transparent plastic substrate 10 that includes a ceiling part 10a, and a side wall part 10b extending vertically downward from the ceiling part 10a; a coating film 11 having a chromatic color with transparency that is formed on the top face of the ceiling part 10a and an outer wall of the side wall part 10b of the substrate 10; a coating film 12 that is silver, gold or a whitish color including white, and is formed on the coating film 11; and a transparent protective film 13 that is formed on the coating film 12 and a part of the coating film 11, and protects the coating films 11 and 12. The coating film 11 serves as a first layer, the coating film 12 serves as a second layer, and the protective film 13 serve as a third layer.

A part of the coating film 12 is removed by the laser cutting, and a part of the coating film 11 is exposed. The exposed part of the coating film 11 becomes the character part 3 of FIG. 1B. The character part 3 transmits a light 21 from a light source 20 such as the backlight or the light guide plate.

The coating film 11 is made of a paint in which a transparent paint and a chromatic color paint are mixed, for example. Here, the chromatic color has a color tone as red, green, blue, yellow or purple, and an achromatic color has no color tone as white, black or gray. The coating film 12 is made of any one of paints of the whitish color, silver or gold and shields the light 21 from the light source 20. The protective film 13 is made of a transparent paint or an UV (ultraviolet) coating agent.

The contrast ratio between the color of the coating film 12 and the color of the coating film 11 at the time of non-lighting of the light source 20 is 3:1 or more. This means that the contrast ratio between the color of the coating film 12 and the color of the coating film 11 at the time of non-lighting of the light source 20 is 3:1, 4.5:1, 7:1 or the like. Here, the contrast ratio is defined in JIS (Japanese Industrial Standards) X8341-3 (2010). The reason why the contrast ratio between the color of the coating film 12 and the color of the coating film 11 at the time of non-lighting of the light source 20 is 3:1 is that, when the contrast ratio is less than 3:1, the visibility of the character part 3 at the time of non-lighting of the light source 20 is deteriorated.

Moreover, a luminance of the light 21 passing through the character part 3 at the time of lighting of the light source 20 is 3 cd (candela)/cm² or more. That is to say, the character part 3 makes the light having the luminance of 3 cd/cm² or more pass through. The reason why the luminance of the light 21 passing through the character part 3 at the time of lighting of the light source 20 is 3 cd (candela)/cm² or more is that, when the luminance of the light 21 passing through the character part 3 at the time of lighting of the light source 20 is less than 3 cd/cm², the emission of the light from the character part 3 becomes insufficient and the visibility of the character part 3 is deteriorated.

When a shielding performance of the coating film 12 of FIG. 2A is insufficient, a coating film 14 may be formed between the coating film 11 and the coating film 12, as illustrated in FIG. 2B. The coating film 14 is made of a black or gray paint on which the laser cutting is easily performed and which shields the light 21 from the light source 20. The coating film 14 serves as a fourth layer and does not affect the coating film 12 which is an appearance color.

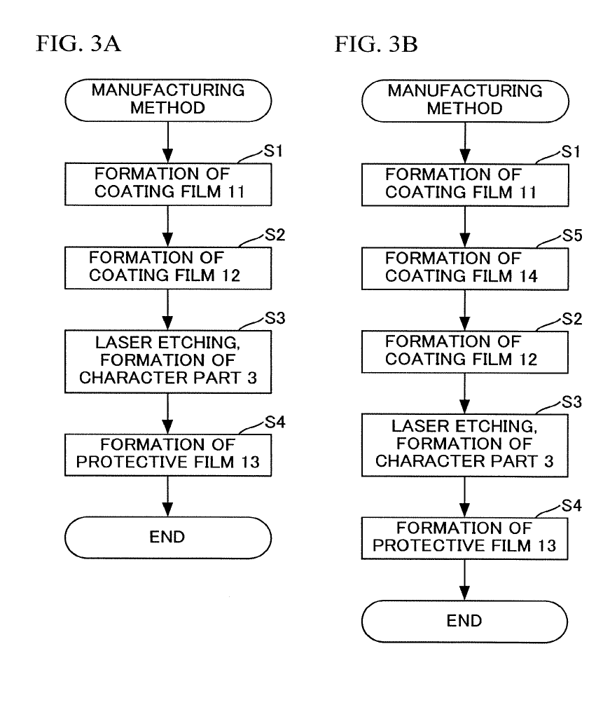

FIG. 3A is a flowchart illustrating a method of manufacturing the key top 2. FIG. 3B is a flowchart illustrating a variation of FIG. 3A. A manufacturing apparatus of the key top 2 is well known.

In FIG. 3A, applying the paint in which the transparent paint and the chromatic color paint are mixed to the top face of the ceiling part 10a and the outer wall of the side wall part 10b of the substrate 10 forms the coating film 11 on the substrate 10 (S1). Next, applying any one of paints of silver, gold or the whitish color including white to the coating film 11 forms the coating film 12 on the coating film 11 (S2). Then, the part of the coating film 12 corresponding to the character part 3 is cut off by laser etching to expose the coating film 11 and form the character part 3 (S3). Finally, the transparent paint is applied on the coating film 12 and the part of the coating film 11 corresponding to the character part 3 and is dried, alternatively the UV coating agent is applied on the coating film 12 and the part of the coating film 11 corresponding to the character part 3 and the ultraviolet is irradiated thereon, and hence the protective film 13 is formed on the coating film 12 and the part of the coating film 11 corresponding to the character part 3 (S4).

Here, when the coating film 14 of FIG. 2B is formed after the process S1, applying the black or gray paint to the coating film 11 forms the coating film 14 on the coating film 11, as illustrated in FIG. 3B (S5). In S2, the coating film 12 is formed on the coating film 14. Moreover, in S3, a part of the coating films 12 and 14 corresponding to the character part 3 is cut off by the laser etching.

As described above, according to the first embodiment, the key top 2 includes: the transparent substrate 10 that includes the ceiling part 10a, and the side wall part 10b extending vertically downward from the ceiling part 10a; the coating film 11 having the chromatic color with transparency that is formed on the top face of the ceiling part 10a and the outer wall of the side wall part 10b; the coating film 12 that is the whitish color, white, silver or gold, is formed on the coating film 11, and shields the light 21 from the light source 20, a part of the coating film 12 corresponding to the character part 3 being removed; wherein the contrast ratio between the color of the coating film 12 and the color of the coating film 11 at the time of non-lighting of the light source 20 is 3:1 or more, and the luminance of the light 21 passing through the character part 3 at the time of lighting of the light source 20 is 3 cd/cm² or more.

Therefore, even when the part other than the character part 3 is a color other than the blackish color, it is possible to improve the visibility of the character part 3 at the time of lighting and non-lighting of the light source 20. Moreover, since the coating film 11 is the chromatic color with transparency, a transmittance is high. Therefore, the coating film 11 hardly absorbs an energy at the time of the laser cutting not to be cut.

### Second Embodiment

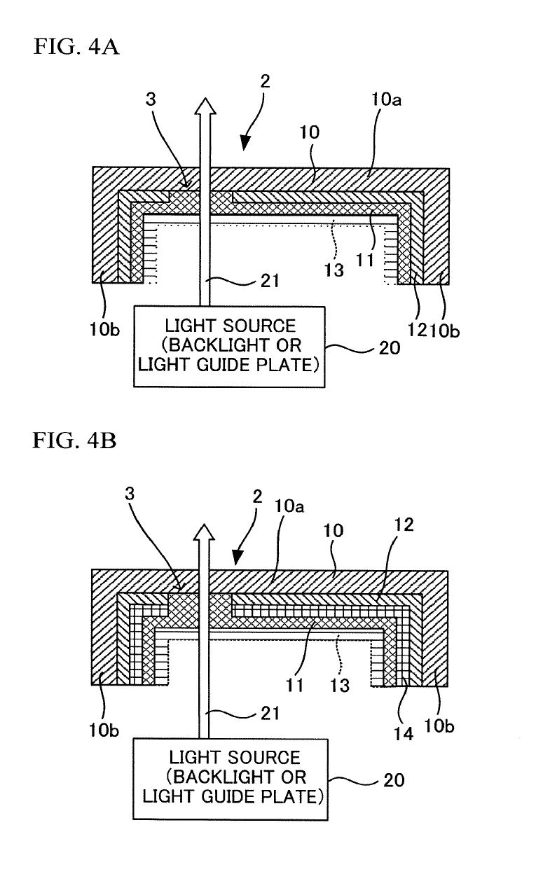

Corresponding component elements to those of the key top 2 in the first embodiment are designated by the same reference numerals, and description of these component elements is omitted. FIG. 4A is a cross-section diagram taken along line A-A of FIG. 1B according to a second embodiment. FIG. 4B is a diagram illustrating a variation of FIG. 4A.

In FIG. 4A, the coating film 12 is formed on a bottom face of the ceiling part 10a and an inner wall of the side wall part 10b of the substrate 10. A part of the coating film 12 is removed by the laser cutting, and a part of the bottom face of the ceiling part 10a is exposed. The exposed part of the bottom face of the ceiling part 10a becomes the character part 3 of FIG. 1B. The character part 3 transmits the light 21 from the light source 20 such as the backlight or the light guide plate. The coating film 11 is formed under the coating film 12 and the exposed part of the bottom face of the ceiling part 10a.

In the second embodiment, the protective film 13 that protects the coating film 11 is not provided. This is because the coating film 11 is formed on the back side of the key top 2, an operator is not in directly contact with the coating film 11 and hence there is no wear on the coating film 11. Here, the protective film 13 may be formed on the coating film 11.

When the shielding performance of the coating film 12 of FIG. 4A is insufficient, the coating film 14 may be fanned between the coating film 11 and the coating film 12, as illustrated in FIG. 4B.

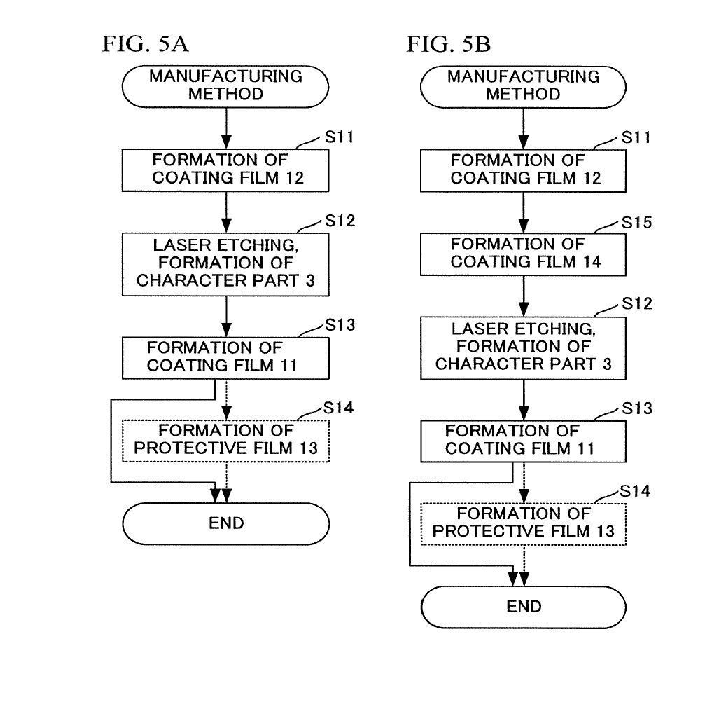

FIG. 5A is a flowchart illustrating a method of manufacturing the key top 2 according to the second embodiment. FIG. 5B is a flowchart illustrating a variation of FIG. 5A. The manufacturing apparatus of the key top 2 is well known.

In FIG. 5A, applying any one of paints of silver, gold or the whitish color to the bottom face of the ceiling part 10a and the inner wall of the side wall part 10b of the substrate 10 forms the coating film 12 on the bottom face of the ceiling part 10a and the inner wall of the side wall part 10b (S11). Next, the part of the coating film 12 corresponding to the character part 3 is cut off by the laser etching to expose the part of the bottom face of the ceiling part 10a and form the character part 3 (S12). Then, the paint in which the transparent paint and the chromatic color paint are mixed is applied to the coating film 12 and the exposed part of the bottom face of the ceiling part 10a, and hence the coating film 11 is foiiiied on the coating film 12 and the exposed part of the bottom face of the ceiling part 10a (S13). The present processing is terminated.

Here, when the protective film 13 is formed after the process S13, the transparent paint is applied on the coating film 11 and is dried, alternatively the UV coating agent is applied on the coating film 11 and the ultraviolet is irradiated thereon, and hence the protective film 13 is formed on the coating film 11 (S14).

Moreover, when the coating film 14 of FIG. 4B is formed after the process S11, applying the black or gray paint to the coating film 12 forms the coating film 14 on the coating film 12, as illustrated in FIG. 5B (S15). In S12, the part of the coating films 12 and 14 corresponding to the character part 3 is cut off by the laser etching. Moreover, in S13, the coating film 11 is formed on the coating film 14 and the exposed part of the bottom face of the ceiling part 10a.

As described above, according to the second embodiment, the key top 2 includes: the transparent substrate 10 that includes the ceiling part 10a, and the side wall part 10b extending vertically downward from the ceiling part 10a; the coating film 12 that is the whitish color, white, silver or gold, is formed on the bottom face of the ceiling part 10a and the inner wall of the side wall part 10b, and shields the light 21 from the light source 20, a part of the coating film 12 corresponding to the character part 3 being removed; and the coating film 11 having the chromatic color with transparency that is formed on the coating film 12 and the part of the bottom face of the ceiling part 10a exposed by removal of the part of the coating film 12; wherein the contrast ratio between the color of the coating film 12 and the color of the coating film 11 at the time of non-lighting of the light source 20 is 3:1 or more, and the luminance of the light 21 passing through the character part 3 at the time of lighting of the light source 20 is 3 cd/cm² or more.

Therefore, even when the part other than the character part 3 is a color other than the blackish color, it is possible to improve the visibility of the character part 3 at the time of lighting and non-lighting of the light source 20.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A key top comprising:
a transparent substrate that includes a ceiling part, and a side wall part extending vertically downward from the ceiling part;
a first layer having a chromatic color with transparency that is formed on a top face of the ceiling part and an outer wall of the side wall part or a bottom face of the ceiling part and an inner wall of the side wall part; and
a second layer that is a whitish color, white, silver or gold, is formed on the first layer, and shields a light from a light source, a part of the second layer corresponding to a character part being removed;
wherein a contrast ratio between a color of the second layer and a color of the first layer at the time of non-lighting of the light source is 3:1 or more, and a luminance of the light passing through the character part at the time of lighting of the light source is 3 cd/cm² or more.

2. The key top as claimed in claim 1, further comprising:
a transparent third layer that is formed on the second layer and a part of the first layer exposed by removal of the part of the second layer.

3. The key top as claimed in claim 1, further comprising:
a black or gray fourth layer that is formed between the first layer and the second layer; and shields the light from the light source, a part of the fourth layer corresponding to the character part being removed.

4. A keyboard comprising:
a key top as claimed in claim 1.
